(19) United States
(12) Patent Application Publication
(10) Pub. No.: US 2021/0102619 A1
(43) Pub. Date: Apr. 8, 2021

(54) EPICYCLIC GEAR SYSTEM HAVING DIRECTING MEMBER AND METHOD OF DIRECTING A FLUID IN AN EPICYCLIC GEAR SYSTEM

(71) Applicant: DEERE & COMPANY, Moline, IL (US)

(72) Inventor: MICHAEL J. CLIFF, COFFEYVILLE, KS (US)

(21) Appl. No.: 16/592,242

(22) Filed: Oct. 3, 2019

(51) Int. Cl. F16H 57/04; F16H 1/28

(52) U.S. Cl. CPC F16H 57/0431; F16H 1/28

(57) ABSTRACT

A directing member and a method of directing a fluid is provided for an epicyclic gear system having a sun gear, a plurality of planet gears, and a carrier connecting the plurality of planet gears and rotating relative to the sun gear. The directing member is disposed radially outside of the sun gear and is configured for movement relative to the outer periphery of the sun gear. The directing member includes an inner surface configured to receive the fluid discharged from the fluid passage and direct the fluid radially inwardly toward the sun gear.

### BACKGROUND

Epicyclic gear systems include a sun gear that is centrally located on a central shaft. The sun gear is in meshed engagement with a plurality of planetary or planet gears, and the planet gears are in meshed engagement with an outer ring gear. The planet gears are rotatably mounted on a carrier that may rotate relative to the sun gear. A second shaft may be coupled to the carrier to receive torque from or supply torque to the epicyclic gear system. A speed and torque difference may be realized between the central shaft and the second shaft. An oil or lubricant may be circulated through one or more components or gears of the epicyclic gear system in order to reduce the operating temperature of the system and/or individual components of the system.

### SUMMARY

Various aspects of embodiments of the present disclosure are set out in the claims.

In accordance with an embodiment of the present disclosure, an epicyclic gear system is provided. The epicyclic gear system includes a sun gear having an outer periphery and a fluid passage configured to discharge a fluid radially outwardly from the outer periphery, a plurality of planet gears disposed around the sun gear, a carrier connecting the plurality of planet gears and configured for rotation relative to the sun gear, and at least one directing member disposed radially outside of the sun gear and configured for movement relative to the outer periphery of the sun gear, the at least one directing member comprising an inner surface configured to receive the fluid discharged from the fluid passage and direct the fluid radially inwardly toward the sun gear.

In accordance with an embodiment of the present disclosure, a directing member for an epicyclic gear system having a sun gear, a plurality of planet gears, and a carrier connecting the plurality of planet gears and rotating relative to the sun gear is provided. The directing member includes an inner surface having a receiving portion extending circumferentially, a directing portion extending radially inward, and a connecting portion being curved to join the receiving portion and the directing portion. The receiving portion is configured to receive fluid radially discharged from the sun gear. The directing portion is configured to direct the fluid from the receiving portion and the connecting portion radially inward toward an outer periphery of the sun gear.

In accordance with an embodiment of the present disclosure, a method of directing a fluid in an epicyclic gear system having a sun gear and a plurality of planet gears disposed around the sun gear is provided. The method includes conveying the fluid from the sun gear radially outwardly past an outer periphery of the sun gear, receiving the fluid on an inner surface of a directing member moving across the outer periphery of the sun gear, and directing the fluid with the inner surface of the directing member radially inwardly toward the outer periphery of the sun gear.

The above and other features will become apparent from the following description and accompanying drawings.

### BRIEF DESCRIPTION OF THE DRAWINGS

The detailed description of the drawings refers to the accompanying figures in which:

FIG. 1 is a cross-sectional view of an epicyclic gear system in accordance with an embodiment of the present disclosure;

FIG. 2 is a cross-sectional view of an epicyclic gear system in accordance with an embodiment of the present disclosure;

FIG. 3 is an enlarged cross-sectional view of an epicyclic gear system in accordance with an embodiment of the present disclosure;

FIG. 4 is a cross-sectional view of an epicyclic gear system in accordance with an embodiment of the present disclosure;

FIG. 5 is a cross-sectional view of an epicyclic gear system in accordance with an embodiment of the present disclosure; and

FIG. 6 illustrates a method of directing a fluid in an epicyclic gear system in accordance with an embodiment of the present disclosure.

Like reference numerals are used to indicate like elements throughout the several figures.

### DETAILED DESCRIPTION

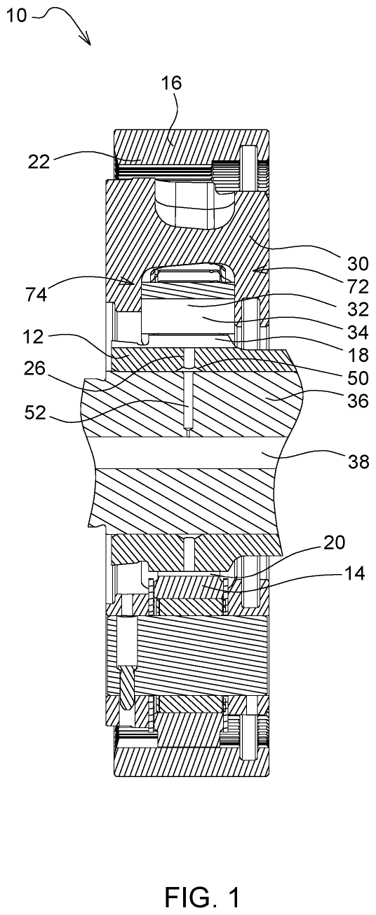

At least one example embodiment of the subject matter of this disclosure is understood by referring to FIGS. 1 through 6 of the drawings.

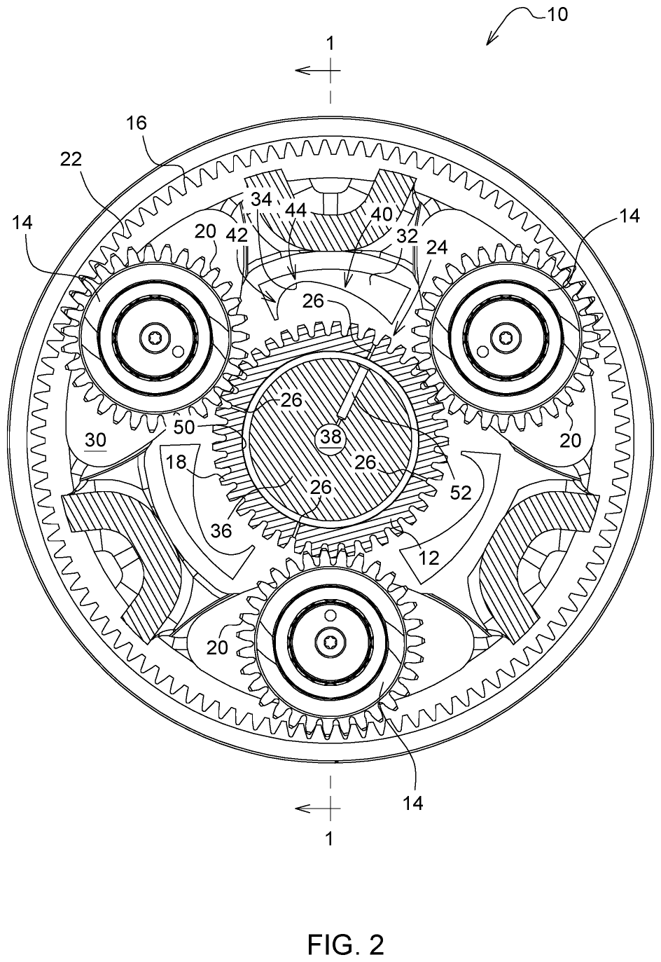

Referring now to FIGS. 1 and 2, an epicyclic gear system 10 is illustrated in accordance with an embodiment of the present disclosure. The system 10 of FIGS. 1 and 2 includes a sun gear 12 and a plurality of planetary or planet gears 14 disposed around the sun gear 12. The sun gear 12 engages the planet gears 14 via sun gear teeth 18 and planet gear teeth 20. The sun gear 12 includes an outer periphery 24 having the sun gear teeth 18. The system 10 of the illustrated embodiment includes a ring gear 16 that is disposed around the planet gears 14 and the sun gear 12 and engages the planet gears 14 via ring gear teeth 22. The system 10 further includes a carrier 30 connecting the planet gears 14. The carrier 30 is configured to rotate relative to the sun gear 12, and the planet gears 14 are rotatably coupled to the carrier 30 such that the planet gears 14 rotate relative to the carrier 30.

The sun gear 12 further includes a fluid passage 26 configured to discharge a fluid 28 radially outwardly from or through the sun gear 12 and past or through the outer periphery 24 such that fluid 28 is radially outwardly discharged from or through the outer periphery 24. The fluid 28 in the illustrated embodiment is an oil or other lubricant, but the fluid 28 of additional embodiments may include any fluid capable of being utilized with the system 10. Central shaft 36 is provided upon which the sun gear 12 is mounted. The fluid 28 travels axially through shaft fluid passage 38 to the fluid passage 26 where the fluid 28 is conveyed radially outwardly by pressure applied to the fluid 28 upstream of the fluid passage 26. In one non-limiting example, the fluid 28 is pumped to the shaft fluid passage 38 by a fluid pump not shown in the illustrated embodiments. In additional embodiments, the fluid 28 is conveyed radially outwardly by centrifugal or other means. In the illustrated embodiment, the fluid passage 26 initially travels through a shaft radial passage 52 before reaching a distribution channel 50 and the fluid passage 26. The fluid passage 26 in the illustrated embodiment includes multiple fluid passages 26 connected to the distribution channel 50. In further embodiments, the fluid passage 26 may include any number of parts or segments, formed with any direction or angle, to convey the fluid 28 radially outwardly through the sun gear 12. In additional embodiments not illustrated, the fluid passage 26 includes passage(s) formed at one or both axial ends of the sun gear 12 such that the fluid 28 flows, leaks, or is otherwise conveyed radially outwardly past the sun gear 12.

The system 10 of the illustrated embodiments further includes one or more directing members 32 disposed radially outside of the sun gear 12. Each directing member 32 of the illustrated embodiment of FIGS. 1 and 2 is configured to be coupled to or integrally formed with the carrier 30 such that the directing member 32 moves or is configured for movement relative to the outer periphery 24 of the sun gear 12. The directing member 32 of the illustrated embodiment includes a plurality of directing members 32 each disposed circumferentially between pairs of planet gears 14 to form three directing members 32 in the system 10, as shown in FIG. 1. However, in additional embodiments not illustrated, the system 10 includes one, two, four, or more directing members 32.

The directing member(s) 32 of an embodiment connects or is configured to connect a first side 72 of the carrier 30 to a second side 74 of the carrier 30, and the plurality of planet gears 14 is disposed between the first side 72 of the carrier 30 and the second side 74 of the carrier 30. In one embodiment, each directing member 32 is circumferentially aligned or is configured to be circumferentially aligned with the plurality of planet gears 14. Each directing member 32 of the illustrated embodiment is disposed or is configured to be disposed radially inward, at least partially, of an axis of rotation of each of the plurality of planet gears 14. In a further embodiment of the present disclosure, each directing member 32 is disposed or is configured to be disposed completely radially inward of the axis of rotation of each of the plurality of planet gears 14.

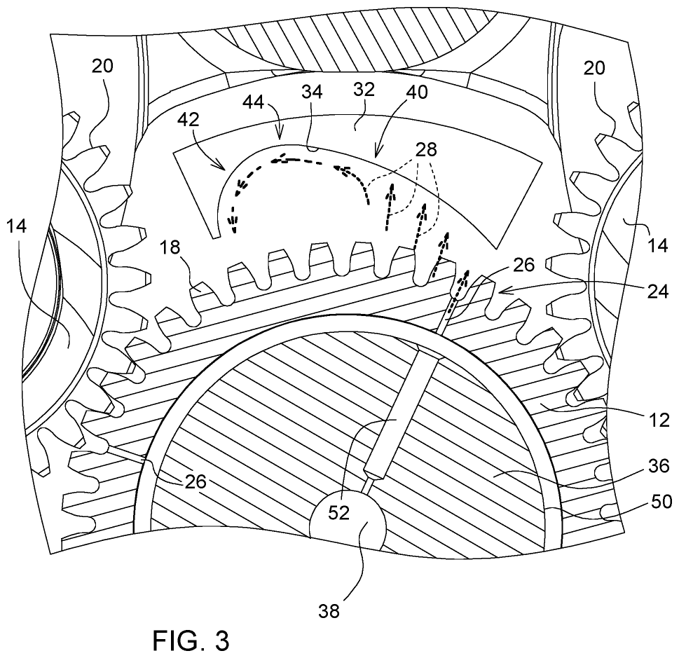

Referring now to FIG. 3 with continuing reference to FIGS. 1 and 2, the directing member 32 includes an inner surface 34 at a radially inner side of the directing member 32. The inner surface 34 of the directing member 32 includes a receiving portion 40 configured to receive the fluid 28 from the fluid passage 26 and at least one directing portion 42 configured to direct the fluid 28 radially inwardly toward the sun gear 12. The directing member 32 of at least one embodiment returns or is configured to return the fluid 28 discharged from the fluid passage 26 and through the outer periphery 24 of the sun gear 12 back to the outer periphery 24 of the sun gear 12. Accordingly, the directing member 32 of the embodiments described herein may be referred to as a director, a directing portion, a returner, a returning member, and/or a returning portion. The directing portion(s) 42 of the embodiments of the various embodiments described herein may form or otherwise contribute to a concave inner surface 34.

The receiving portion 40 of the illustrated embodiments extends circumferentially or at least generally circumferentially. The directing portion(s) 42 of the illustrated embodiment extends radially inwardly or at least generally radially inwardly. It will be appreciated that, in at least some embodiments, the receiving portion 40 of an embodiment extends circumferentially relative to the directing portion(s) 42 and/or the directing portion(s) 42 extends radially inwardly relative to the receiving portion 40.

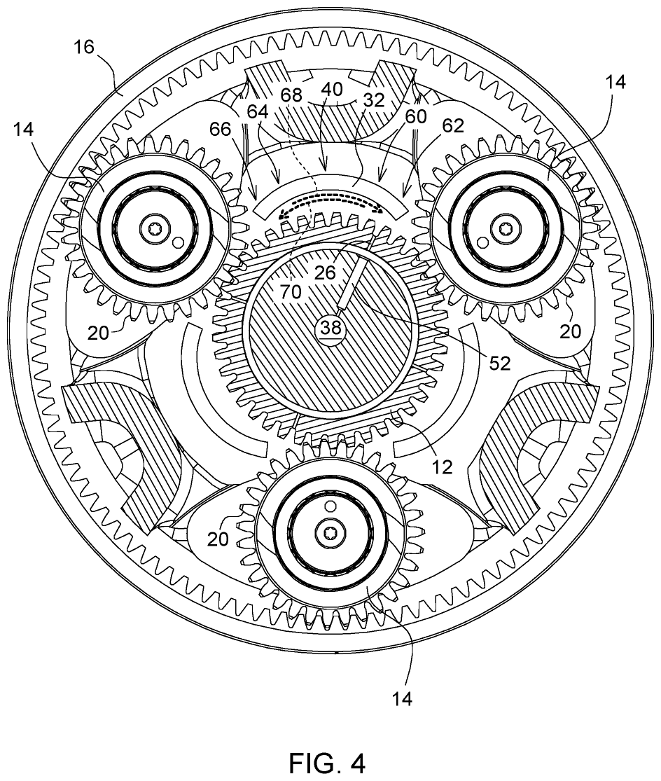

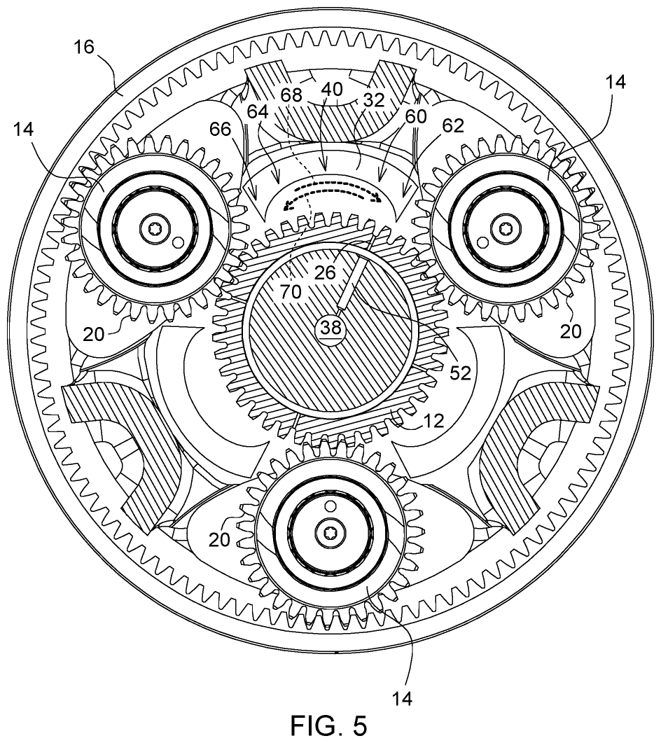

In FIGS. 4 and 5, each directing member 32 of one or more embodiments includes two or more directing portions 42. As illustrated in FIGS. 4 and 5 and as discussed in further detail below, two directing portions 42 are positioned at opposite ends of the receiving portion 40.

As illustrated in FIGS. 3-5, the receiving portion 40 and the directing portion(s) 42 are connected via a connecting portion 44 having a curved surface and/or being curved to join the receiving portion 40 and the directing portion(s) 42. Referring again to FIG. 4 and FIG. 5, the system 10 of an embodiment includes one or more directing members 32 each having two directing portions 42 configured to direct the fluid 28 radially inwardly toward the sun gear 12 and two connecting portions 44 connecting the receiving portion 40 to the two directing portions 42.

The system 10 of the embodiments illustrated in FIGS. 4 and 5 includes a first connecting portion 60 disposed between the receiving portion 40 and a first directing portion 62 and a second connecting portion 64 disposed between the receiving portion 40 and a second directing portion 66. The first directing portion 62 directs or is configured to direct the fluid 28 from the receiving portion 40 and the first connecting portion 60 radially inwardly toward the outer periphery 24 of the sun gear 12 when the carrier 30 rotates in a first direction 68 relative to the sun gear 12. The second directing portion 66 directs or is configured to direct the fluid 28 from the receiving portion 40 and the second connecting portion 64 radially inwardly toward the outer periphery 24 of the sun gear 12 when the carrier 30 rotates in a second direction 70 relative to the sun gear 12.

It will be appreciated that, in the illustrated embodiments, the connecting portion(s) 44 is generally identified as the transitional region having any particular length between the circumferentially extending receiving portion 40 an the radially inwardly extending directing portion(s) 42. Further, the receiving portion 40, the directing portion(s) 42, and/or the connecting portion(s) 44 may be designed or configured, in particular embodiments, based on the velocity of the directing member(s) 32 relative to the sun gear 12. In a non-limiting example, the directing portion(s) 42 of the directing member 32 traveling at a relatively low speed relative to the sun gear 12 of one embodiment may have a smaller radius and/or may extend further in a radially inward direction compared to the directing portion(s) 42 of the directing member 32 of another embodiment that is configured to travel at a higher speed relative to the sun gear 12.

In the illustrated embodiments, the receiving portion 40, the directing portion(s) 42, and the connecting portion(s) 44 cooperate to form a continuously curved surface 48. The continuously curved surface 48 is or includes a decreasing radius curved surface in the illustrated embodiment. The radius of the continuously curved surface 48 is configured to decrease in a direction of flow of the fluid 28 across, along, or against the directing member 32. In one or more embodiments, the receiving portion 40, the directing portion(s) 42, and/or the connecting portion(s) 44 include(s), individually or in combination, any configuration of constant, increasing, and/or decreasing radius curved surface.

FIG. 4 illustrates an embodiment of the present disclosure whereby the directing member 32 includes the directing portions 42 and the receiving portion 40 forming a constant radius curve at the inner surface 34. The constant radius curve at the inner surface 34 includes a curve that is substantially constant, or having one or more radii differing by up to 10% of another radius of the substantially constant radius curve in particular embodiments.

FIG. 5 illustrates an embodiment of the present disclosure whereby each directing member 32 includes each of two directing portions 42 and the receiving portion 40 forming a varying or not substantially constant radius curve at the inner surface 34. In the embodiment illustrated in FIG. 5, the directing portions 42 have a radius curve at the inner surface 34 that is less than a radius curve at the inner surface 34 of the receiving portion 40. In additional embodiments not illustrated, the two directing portions 42 have any number of radius curves at the inner surface 34 that are different from each other, in order to, in particular non-limiting examples, accommodate a difference in rotational speeds or movement speeds of the directing member 32 depending on carrier rotation direction.

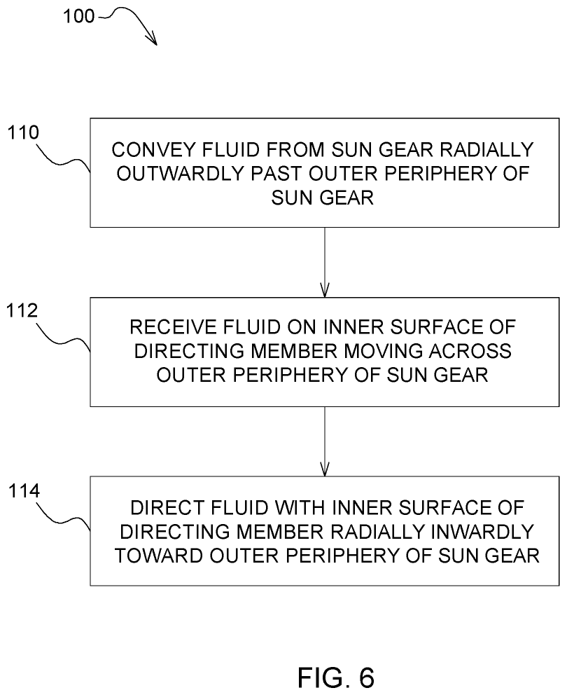

Referring now to FIG. 6, a method 100 of directing the fluid 28 in the epicyclic gear system 10 is provided. The method 100 includes conveying, at step 110, the fluid 28 from the sun gear 12 radially outwardly past or through the outer periphery 24 of the sun gear 12. The method 100 further includes receiving, at step 112, the fluid 28 on the inner surface 34 of the directing member 32 moving across or around the outer periphery 24 of the sun gear 12. The method 100 further includes directing, at step 114, the fluid 28 with the inner surface 34 of the directing member 32 radially inwardly toward the outer periphery 24 of the sun gear 12.

In one or more additional embodiments, the method 100 further includes rotating the carrier 30 connected to the directing member 32 in the first direction 68 or the second direction 70 relative to the sun gear 12. Directing the fluid 28 with the inner surface 34 of the directing member 32 includes, in an embodiment, directing the fluid 28 with the first directing portion 62 when rotating the carrier 30 in the first direction 68 and directing the fluid 28 with the second directing portion 66 when rotating the carrier 30 in the second direction 70. In an embodiment, receiving the fluid 28 on the inner surface 34 of the directing member 32 and directing the fluid 28 with the inner surface 34 of the directing member 32 includes receiving the fluid 28 on the inner surface 34 of each of the directing members 32 and directing the fluid 28 with the inner surface 34 of each of the directing members 32.

Further embodiments of the system 10 and the method 100 of the present disclosure include one or more directing members 32 disposed outside of any other type of gear different from the sun gear 12. In one non-limiting example, an inner fluid-emitting member such as any gear having gear teeth, emits or is configured to emit the fluid 28 radially outwardly toward a rotating or moving member, housing, or other structure. The rotating or moving member, housing, or other structure includes one or more features or functions of the directing member 32 described herein to direct, redirect or return the fluid 28 to the inner fluid-emitting member or gear.

Without in any way limiting the scope, interpretation, or application of the claims appearing below, it will be appreciated that the embodiments of the present disclosure provide the system 10 and the method 100 to supply the fluid 28, such as an oil, to the sun gear 12 to increase oil circulation at and/or around the sun gear 12 for improved lubrication and cooling of the sun gear 12 and the system 10. Further, the system 10 and the method 100 utilizes the rotation or motion of the carrier 30 to recirculate, direct, redirect, or return the fluid 28 to the sun gear 12 without the need for an additional pump, fluid passage or other structure or means. Even further, the system 10 and the method provide structure and means to recirculate, direct, redirect, or return the fluid 28 to the sun gear 12 regardless of a direction of rotation or motion of the carrier 30 relative to the sun gear 12.

As used herein, “e.g.” is utilized to non-exhaustively list examples and carries the same meaning as alternative illustrative phrases such as “including,” “including, but not limited to,” and “including without limitation.” As used herein, unless otherwise limited or modified, lists with elements that are separated by conjunctive terms (e.g., “and”) and that are also preceded by the phrase “one or more of,” “at least one of,” “at least,” or a like phrase, indicate configurations or arrangements that potentially include individual elements of the list, or any combination thereof. For example, “at least one of A, B, and C” and “one or more of A, B, and C” each indicate the possibility of only A, only B, only C, or any combination of two or more of A, B, and C (A and B; A and C; B and C; or A, B, and C). As used herein, the singular forms “a”, “an” and “the” are intended to include the plural forms as well, unless the context clearly indicates otherwise. Further, “comprises,” “includes,” and like phrases are intended to specify the presence of stated features, steps, operations, elements, and/or components, but do not preclude the presence or addition of one or more other features, steps, operations, elements, components, and/or groups thereof.

While the present disclosure has been illustrated and described in detail in the drawings and foregoing description, such illustration and description is not restrictive in character, it being understood that illustrative embodiment(s) have been shown and described and that all changes and modifications that come within the spirit of the present disclosure are desired to be protected. Alternative embodiments of the present disclosure may not include all of the features described yet still benefit from at least some of the advantages of such features. Those of ordinary skill in the art may devise their own implementations that incorporate one or more of the features of the present disclosure and fall within the spirit and scope of the appended claims.

What is claimed is:

1. An epicyclic gear system comprising:
a sun gear having an outer periphery and a fluid passage configured to discharge a fluid radially outwardly from the outer periphery;
a plurality of planet gears disposed around the sun gear;
a carrier connecting the plurality of planet gears and configured for rotation relative to the sun gear; and
at least one directing member disposed radially outside of the sun gear and configured for movement relative to the outer periphery of the sun gear, the at least one directing member comprising an inner surface configured to receive the fluid discharged from the fluid passage and direct the fluid radially inwardly toward the sun gear.

2. The system of claim 1, wherein the at least one directing member comprises a receiving portion configured to receive the fluid from the fluid passage and at least one directing portion configured to direct the fluid radially inwardly toward the sun gear.

3. The system of claim 2, wherein the receiving portion and the at least one directing portion are connected via at least one connecting portion having a curved surface.

4. The system of claim 2, wherein the receiving portion, the at least one directing portion, and the at least one connecting portion cooperate to form a continuously curved surface.

5. The system of claim 4, wherein the continuously curved surface comprises a decreasing radius curved surface.

6. The system of claim 1, wherein the at least one directing member comprises two directing portions configured to direct the fluid radially inwardly toward the sun gear and two connecting portions connecting the receiving portion to the two directing portions.

7. The system of claim 6, wherein the two directing portions, the receiving portion, and the two connecting portions form a continuously curved surface.

8. The system of claim 1, wherein the at least one directing member comprises a plurality of directing members each disposed circumferentially between pairs of the plurality of the planet gears.

9. A directing member for an epicyclic gear system having a sun gear, a plurality of planet gears, and a carrier connecting the plurality of planet gears and rotating relative to the sun gear, the directing member comprising:
an inner surface having a receiving portion extending circumferentially, a directing portion extending radially inward, and a connecting portion being curved to join the receiving portion and the directing portion;
wherein the receiving portion is configured to receive fluid radially discharged from the sun gear; and
wherein the directing portion is configured to direct the fluid from the receiving portion and the connecting portion radially inward toward an outer periphery of the sun gear.

10. The directing member of claim 9, wherein the directing portion comprises a first directing portion and a second directing portion disposed at opposite ends of the receiving portion;
wherein the connecting portion comprises a first connecting portion disposed between the receiving portion and the first directing portion and a second connecting portion disposed between the receiving portion and the second directing portion;
wherein the first directing portion is configured to direct the fluid from the receiving portion and the first connecting portion radially inwardly toward the outer periphery of the sun gear when the carrier rotates in a first direction relative to the sun gear; and
wherein the second directing portion is configured to direct the fluid from the receiving portion and the second connecting portion radially inwardly toward the outer periphery of the sun gear when the carrier rotates in a second direction relative to the sun gear.

11. The directing member of claim 9, wherein the directing member is configured to connect a first side of the carrier to a second side of the carrier, wherein the plurality of planet gears is disposed between the first side of the carrier and the second side of the carrier.

12. The directing member of claim 9, wherein the directing member is configured to be circumferentially aligned with the plurality of planet gears.

13. The directing member of claim 9, wherein the directing member is configured to be disposed radially inward of an axis of rotation of each of the plural of planet gears.

14. A method of directing a fluid in an epicyclic gear system having a sun gear and a plurality of planet gears disposed around the sun gear, the method comprising:
conveying the fluid from the sun gear radially outwardly past an outer periphery of the sun gear;
receiving the fluid on an inner surface of a directing member moving across the outer periphery of the sun gear; and
directing the fluid with the inner surface of the directing member radially inwardly toward the outer periphery of the sun gear.

15. The method of claim 14, further comprising:
rotating a carrier connected to the directing member in one of a first direction and a second direction relative to the sun gear, wherein directing the fluid with the inner surface of the directing member comprises directing the fluid with a first directing portion when rotating the carrier in the first direction and directing the fluid with a second directing portion when rotating the carrier in the second direction.

16. The method of claim 14, wherein receiving the fluid on the inner surface of the directing member and directing the fluid with the inner surface of the directing member comprises receiving the fluid on the inner surface of each of a plurality of directing members and directing the fluid with the inner surface of each of the plurality of directing members.
